(19) United States
(12) Patent Application Publication
(10) Pub. No.: US 2025/0340134 A1
(43) Pub. Date: Nov. 6, 2025

(54) FUEL CELL PLACEMENT FOR REFUSE VEHICLE

(71) Applicant: Oshkosh Corporation, Oshkosh, WI (US)

(72) Inventors: Nick Weykamp, Oshkosh, WI (US); Jeff Verhagen, Oshkosh, WI (US)

(73) Assignee: Oshkosh Corporation, Oshkosh, WI (US)

(21) Appl. No.: 19/197,709

(22) Filed: May 2, 2025

Related U.S. Application Data
(60) Provisional application No. 63/642,050, filed on May 3, 2024.

(51) Int. Cl. B60L 50/75; B60K 15/03; B60K 15/067; B60L 1/00; B60L 58/40; B60R 16/023; B62D 21/02; B65F 3/02; F17C 13/08

(52) U.S. Cl. CPC B60L 50/75; B60K 15/067; B60L 1/003; B60L 58/40; B60R 16/0238; B62D 21/02; B65F 3/02; F17C 13/084; B60K 2015/03315; B65F 2003/0269; B65F 2003/0283; F17C 2205/0323; F17C 2221/012; F17C 2270/0171; F17C 2270/0184

(57) ABSTRACT

A refuse vehicle includes a chassis. The chassis includes a right frame member and a left frame member spaced apart in a lateral direction and extending lengthwise in a longitudinal direction, the right frame member being separate from the left frame member. The refuse vehicle further includes a body supported by the right frame member and the left frame member, the body defining a refuse compartment, and a hydrogen power system including a plurality of fuel cells longitudinally disposed along the chassis, positioned between the right frame member and the left frame member. The hydrogen power system may also include plurality of fuel pods for providing hydrogen to the fuel cells. The hydrogen power system can be packaged in modular pods on various locations of the refuse vehicle. The hydrogen power system can work in conjunction with other power sources or fuels (e.g., electric batteries, ultra-capacitors, diesel ICE, CNG, etc.).

### CROSS-REFERENCE TO RELATED PATENT APPLICATIONS

This application claims the benefit of and priority to U.S. Provisional Application No. 63/642,050, filed May 3, 2024, the entire contents of which are incorporated herein by reference herein.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

One embodiment relates to a refuse vehicle. The refuse vehicle includes a chassis. The chassis includes a right frame member and a left frame member spaced apart in a lateral direction and extending lengthwise in a longitudinal direction, the right frame member being separate from the left frame member. The refuse vehicle further includes a body supported by the right frame member and the left frame member, the body defining a refuse compartment, and a plurality of fuel cells longitudinally disposed along the chassis, positioned between the right frame member and the left frame member.

Another embodiment relates to a refuse vehicle including a chassis and an energy storage device coupled to the chassis, the energy storage device configured to provide electrical power to a prime mover, wherein activation of the prime mover selectively drives the refuse vehicle. The refuse vehicle further includes a body assembly for storing refuse therein supported by the chassis, the body assembly including a plurality of auxiliary power assembly attachment points. The refuse vehicle further includes a plurality of fuel cells selectively coupled to at least one of the plurality of auxiliary power assembly attachment points, wherein the plurality of fuels are configured to provide electrical power to at least one of the energy storage device or the prime mover, and a hydrogen fuel pod selectively coupled to at least one of the plurality of auxiliary power assembly attachment points, the hydrogen fuel pod configured to provide a flow of hydrogen to the plurality of fuel cells.

Another embodiment relates to a refuse vehicle including a chassis and a battery coupled to the chassis, the battery configured to provide electrical power to a electric motor, wherein activation of the electric motor selectively drives the refuse vehicle. The refuse vehicle further includes a body assembly for storing refuse therein supported by the chassis, the body assembly comprising a plurality of auxiliary power assembly attachment points, at least one hydrogen fuel cell contained within a hydrogen fuel cell housing selectively coupled to a first point of the plurality of auxiliary power assembly attachment points, wherein the at least one hydrogen fuel cell is configured to provide electrical power to at least one of the energy storage device or the prime mover, at least one hydrogen fuel pod selectively coupled to a second point of the plurality of auxiliary power assembly attachment points, the hydrogen fuel pod configured to provide a flow of hydrogen to the plurality of fuel cells, wherein the hydrogen fuel pod is contained within a fuel pod housing separate from the hydrogen fuel cell housing.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a refuse vehicle, according to an exemplary embodiment;

FIG. 2 is a schematic of a control system of the refuse vehicle of FIG. 1, according to an exemplary embodiment;

FIG. 3 is a schematic view of a control system including hydrogen power system that can be incorporated into the refuse vehicle of FIG. 1, according to an exemplary embodiment;

FIG. 4 is a side view of the refuse vehicle of FIG. 1 having a bottom mounted pod assembly, according to an exemplary embodiment.

FIG. 5 is a side view of the refuse vehicle of FIG. 1 having a top mounted pod assembly, according to an exemplary embodiment.

FIG. 6 is a side view of the refuse container of FIG. 1 having a centrally mounted pod assembly, according to an exemplary embodiment.

FIG. 7 is a perspective view of the refuse container of FIG. 1 having a tailgate mounted pod assembly, according to an exemplary embodiment.

FIG. 8 is a side view of the refuse container of FIG. 1 having a frame mounted pod assembly, according to an exemplary embodiment.

FIGS. 9A-10B are side views of the refuse vehicle of FIG. 1 having multiple pod assemblies, according to several exemplary embodiments.

FIGS. 11A-11B are the refuse vehicle of FIG. 1 having a top mounted pod assembly, according to several exemplary embodiments.

FIG. 12A is a side view of the refuse vehicle of FIG. 1 having pod assemblies positioned between chassis frame rails of the refuse vehicle, according to an exemplary embodiment.

FIG. 12B is a perspective view of the refuse vehicle of FIG. 1 having pod assemblies positioned between the chassis frame rails of the refuse vehicle, according to an exemplary embodiment.

FIG. 12C is a diagram of a battery positioned between C-shaped chassis frame rails of a refuse vehicle, according to an exemplary embodiment.

FIG. 12D is a diagram of a battery positioned between L-shaped chassis frame rails of a refuse vehicle, according to an exemplary embodiment.

FIG. 13A is a side view of the refuse vehicle of FIG. 1 having pod assemblies positioned between longitudinal body frame members above a chassis of the refuse vehicle, according to an exemplary embodiment.

FIG. 13B is a perspective view of the refuse vehicle of FIG. 1 having pod assemblies positioned between the longitudinal body frame members above the chassis of the refuse vehicle, according to an exemplary embodiment.

FIG. 13C is a diagram of a portion of the refuse vehicle of FIGS. 13A-13B with pod assemblies positioned above the chassis beneath a floor surface of the body, according to an exemplary embodiment.

FIG. 14A is a diagram of a battery positioned between both chassis frame rails and body frame rails of a refuse vehicle, according to an exemplary embodiment.

FIG. 14B is a diagram of stacked pod assemblies positioned between both chassis frame rails and body frame rails of a refuse vehicle, according to an exemplary embodiment.

FIG. 14C is a diagram of a battery positioned between body frame rails of a refuse vehicle, above a chassis of the refuse vehicle, according to an exemplary embodiment.

FIG. 14D is a diagram of a side view of a body and frame of a refuse vehicle, with pod assemblies extending into a space of the body, according to an exemplary embodiment.

FIG. 14E is a diagram of a body and frame of a refuse vehicle, with pod assemblies extending into a space of the body, according to an exemplary embodiment.

FIG. 14F is a diagram of a body and frame of a refuse vehicle, with pod assemblies extending into a space of the body and between chassis frame rails of the refuse vehicle, according to an exemplary embodiment

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

According to an exemplary embodiment, a refuse vehicle may include a hydrogen system configured to power a vehicle (e.g., refuse vehicle) or one or more components thereof. The hydrogen system may use a hydrogen internal combustion engine and/or a hydrogen fuel cell to generate power. More specifically, the hydrogen system includes a hydrogen fuel pod for storing hydrogen and/or a hydrogen generation system for generating hydrogen on the refuse vehicle. The hydrogen is then supplied to the hydrogen power system and used as fuel such that the hydrogen power system generates energy to power one or more components of the vehicle. The hydrogen power system may operate alone or in combination with one or more power systems of the vehicle (e.g., an internal combustion engine, a prime mover, a battery pack, an electric motor, a hydraulic pump, etc.) to power one or more components of the vehicle.

According to an exemplary embodiment the hydrogen system is modular and includes a pod assembly which may include a hydrogen fuel cell and/or a hydrogen fuel pod. The pod assembly may have many advantages over conventional systems. According to various exemplary embodiments, the hydrogen fuel cell and/or the hydrogen fuel pod may be positioned in the pod assembly in various locations on the refuse vehicle such that the hydrogen fuel cell and hydrogen fuel pod are readily accessible for maintenance and for refueling of the hydrogen fuel pod. Additionally, the hydrogen fuel cell and the hydrogen fuel pod or components thereof may be modular such that components can be swapped out or upgraded. For example, a first hydrogen fuel pod can be supplemented by adding a second hydrogen fuel pod to provide additional fuel for a hydrogen fuel cell.

According to various exemplary embodiments, the refuse vehicle includes pod assemblies including at least one hydrogen fuel cells or hydrogen fuel pods positioned in a longitudinal direction between chassis frame rails of the refuse vehicle, between body frame rails of the refuse vehicle, or between both the chassis frame rails of the refuse vehicle and the body frame rails of the refuse vehicle. The hydrogen fuel cells or hydrogen fuel pods may be stacked in a lateral or vertical direction and positioned between the chassis frame rails, between the body frame rails, or between both the chassis and the body frame rails. The chassis frame rails and the body frame rails define a space within which the hydrogen fuel cells or hydrogen fuel pods can be positioned. The hydrogen fuel cells or hydrogen fuel pods can be fastened or coupled with the body frame rails and/or the chassis frame rails depending on configuration and positioning. The hydrogen fuel cell pods or hydrogen fuel pods can be hung from an underside of the body of the refuse vehicle.

### Refuse Vehicle

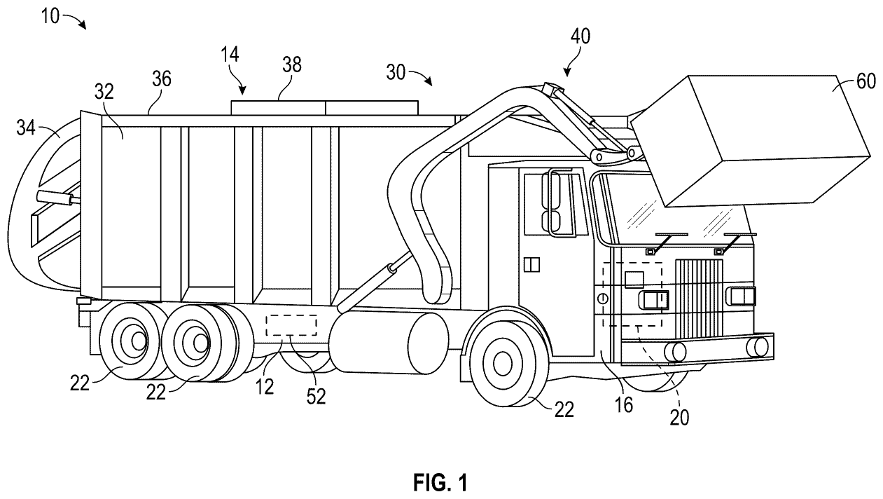

Referring to FIG. 1, a vehicle, shown as refuse vehicle 10 (e.g., garbage truck, waste collection truck, sanitation truck, etc.), includes a chassis, shown as a frame 12; a body assembly, shown as body 14, coupled to the frame 12 (e.g., at a rear end thereof, etc.); and a cab 16, coupled to the frame 12 (e.g., at a front end thereof, etc.). The cab 16 may include various components to facilitate operation of refuse vehicle 10 by an operator (e.g., a seat, a steering wheel, hydraulic controls, a user interface, switches, buttons, dials, etc.). The cab 16 may also include components that can execute commands automatically to control different subsystems within the vehicle (e.g., computers, controllers, processors, etc.). The refuse vehicle 10 further includes a prime mover 20 coupled to the frame 12 at a position beneath the cab 16. The prime mover 20 provides power to a plurality of motive members, shown as wheels 22, and to other systems of the vehicle (e.g., a pneumatic system, a hydraulic system, an electric system, etc.). A pair of wheels 22 may be coupled to an axle. The refuse vehicle 10 may include at least two axles. In some embodiments, the refuse vehicle 10 may include at least four axles, and may include five axles in various embodiments herein.

The prime mover 20 may be configured to use a variety of fuels (e.g., gasoline, diesel, biodiesel, ethanol, natural gas, liquid hydrogen, hydrogen gas, etc.), according to various exemplary embodiments. According to an alternative embodiment, the prime mover 20 includes one or more electric motors coupled to the frame 12. The electric motors may consume electrical power from an on-board storage device (e.g., batteries, ultra-capacitors, etc.), from an on-board generator (e.g., an internal combustion engine, high efficiency solar panels, regenerative braking system, hydrogen power system, etc.), or from an external power source (e.g., overhead power lines) and provide power to the systems of the refuse vehicle 10. According to some embodiments, the refuse vehicle 10 may be in other configurations than shown in FIG. 1.

According to an exemplary embodiment, the refuse vehicle 10 is configured to transport refuse from various waste refuse containers within a municipality to a storage or processing facility (e.g., a landfill, an incineration facility, a recycling facility, etc.). The body 14 includes an on-board refuse container. In the embodiment of FIG. 1, the body 14 and on-board refuse container, in particular, defines a collection chamber 24. In some embodiments, the body 14 includes a plurality of panels, shown as panels 32, a tailgate 34, and a cover 36 that together define the collection chamber 24. Loose refuse may be placed into the refuse compartment 30 where it may thereafter be compacted (e.g., by a packer system, etc.). The refuse compartment 30 may provide temporary storage for refuse during transport to a waste disposal site and/or a recycling facility. In some embodiments, at least a portion of the body 14 and the refuse compartment 30 extend above or in front of the cab 16. According to the embodiment shown in FIG. 1, the body 14 and the refuse compartment 30 are positioned behind the cab 16.

In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (e.g., refuse is loaded into a position of the refuse compartment 30 behind the cab 16 and stored in a position further toward the rear of the refuse compartment 30). In such arrangements, the refuse vehicle 10 may be a front-loading refuse vehicle or a side-loading refuse vehicle. In other embodiments, the storage volume is positioned between the hopper volume and the cab 16. In such embodiments, the refuse vehicle 10 may be a rear-loading refuse vehicle in which refuse is loaded into the vehicle through a tailgate 34 or rear end of the vehicle.

The body 14 further includes a tailgate 34 which is movably (e.g., rotatably, etc.) coupled to the on-board refuse container and is positioned at the rear end of the body 14. The tailgate 34 is configured to pivot about pivot pins positioned along the top surface of the on-board refuse container. In other embodiments, a different connection mechanism may be used to support the tailgate 34 on the body 14.

As shown in FIG. 1, the refuse vehicle 10 includes a lift mechanism/system (e.g., a front-loading lift assembly, etc.), shown as lift assembly 40, coupled to the front end of the body 14. In other embodiments, the lift assembly 40 extends rearward of the body 14 (e.g., a rear-loading refuse vehicle, etc.). In still other embodiments, the lift assembly 40 extends from a side of the body 14 (e.g., a side-loading refuse vehicle, etc.). As shown in FIG. 1, the lift assembly 40 is configured to engage a container (e.g., a residential trash receptacle, a commercial trash receptacle, a container having a robotic grabber arm, etc.), shown as refuse container 60. The lift assembly 40 may include various actuators (e.g., electric actuators, hydraulic actuators, pneumatic actuators, etc.) to facilitate engaging the refuse container 60, lifting the refuse container 60, and tipping refuse out of the refuse container 60 into the hopper volume of the refuse compartment 30 through an opening in the cover 36 or through the tailgate 34. The lift assembly 40 may thereafter return the empty refuse container 60 to the ground. According to an exemplary embodiment, a door, shown as top door 38, is movably coupled along the cover 36 to seal the opening thereby preventing refuse from escaping the refuse compartment 30 (e.g., due to wind, bumps in the road, etc.).

### E-PTO

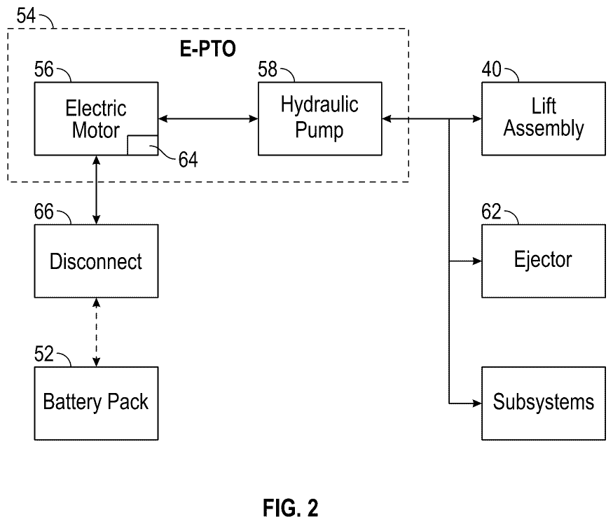

Referring to FIG. 2, in embodiments in which the refuse vehicle is an electric refuse vehicle (e.g., an E-refuse vehicle, etc.) or a hybrid refuse vehicle (e.g., a vehicle including both electric and hydraulic power systems, etc.), the refuse vehicle may further include an onboard energy storage device. In some embodiments, the onboard energy storage device includes a battery pack 52 that provides power to a motor that produces rotational power to drive the refuse vehicle. The energy storage device can be used to provide power to different subsystems on the refuse vehicle. The refuse vehicle may also include an electric power take-off (E-PTO) system, shown as E-PTO system 54, that is configured to receive electrical power from the battery pack 52 and/or other power sources and to convert the electrical power to hydraulic power for different subsystems on the refuse vehicle. In some embodiments, the E-PTO system 54 receives electrical power from the energy storage device and provides the electrical power to an electric motor 56. In such embodiments, the electric motor 56 may drive a hydraulic pump 58 that provides pressurized hydraulic fluid to different vehicle subsystems, such as the lift assembly 40, the packer/ejector, shown as ejector 62, or other subsystems (e.g., the tailgate, etc.).

The E-PTO system may include an E-PTO controller 64. The E-PTO controller 64 may monitor various systems within the refuse vehicle, including the E-PTO system 54. The E-PTO controller 64 may receive data from sensors (not shown) within the system, compare the data to expected values under normal operating conditions, adjust the operation parameters of components of the system, and determine if a critical operating condition exists based on the sensor data. Further, the E-PTO controller 64 may shut down the system and/or the refuse vehicle in response to detecting a critical operating condition. In some embodiments, the refuse vehicle further includes a disconnect 66 positioned between the battery pack 52 and the E-PTO system 54 to allow different vehicle subsystems (e.g., the ejector 62, the lift assembly 40, etc.) to be decoupled and de-energized from the electrical power source. For example, the E-PTO controller 64 may cause the disconnect 66 to be decoupled and de-energized from the electrical power source.

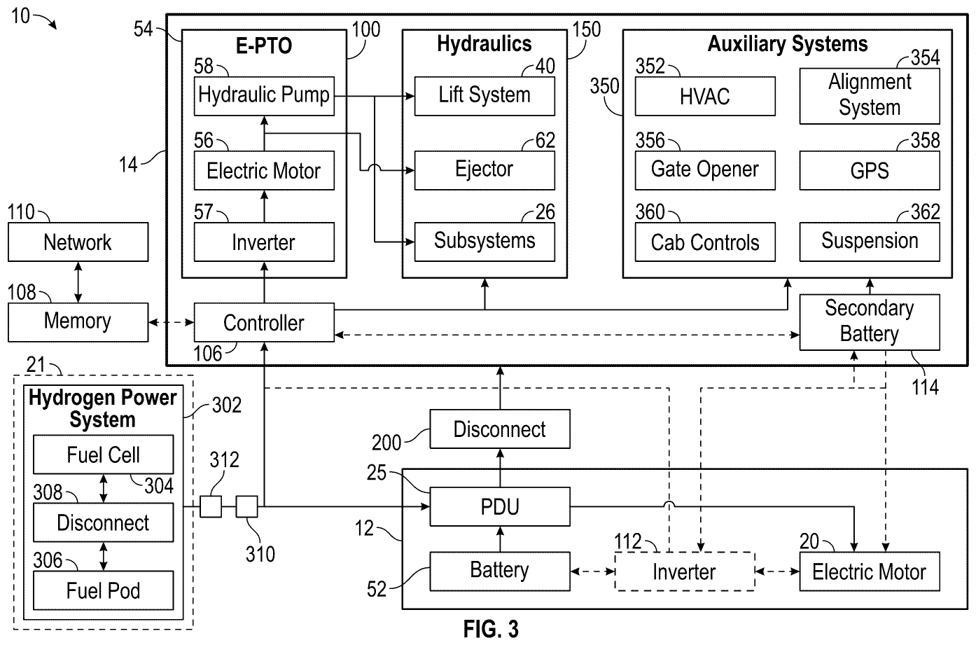

As shown in FIG. 3, the refuse vehicle 10 may further include hydraulics 150 and auxiliary systems 350 that are in communication with a central controller 106. The central controller communicates with the PDU 25 to issue electrical power requests that can then be processed and/or otherwise handled by the PDU 25 to transmit electrical power from an onboard energy storage device, such as battery pack 52 through to the body 14 and to the systems to be powered. As depicted in FIG. 3, the controller 106 is in communication with a memory 108 (e.g., a cloud-based memory, an archive, a database, onboard memory, etc.) that can supply a variety of different control parameters and information to execute different vehicle functions. In some examples, the memory 108 is in communication with a network 110 (e.g., the internet, a fleet management system, etc.) that provides information to the memory 108 for use by the refuse truck 10. For example, route-based data or past performance data can be provided to the refuse truck 10 through the network 110 and/or the memory 108 to the controller 106.

The controller 106 can distribute electrical power received from the battery pack 52 and PDU 25 to the various different systems on the refuse truck 10, including an E-PTO system 54, hydraulics 150, and various auxiliary systems 350. The E-PTO system 54, for example, is configured to receive electrical power from the batteries 52 and convert the electrical power to hydraulic power. The hydraulic pump 58 pressurizes hydraulic fluid onboard the refuse truck 10, which can then be supplied to various hydraulic cylinders and actuators present upon the body 14 of the refuse truck 10. The hydraulic pump 58 can be a swashplate-type variable displacement pump, for example, that supplies all the hydraulics 150 upon the refuse truck 10. The hydraulics 150 can be in communication with the controller 106, which can communicate with the electric motor 56 and hydraulic pump 58 to deliver the desired hydraulic loads. Simultaneously, the controller 106 can communicate with the PDU 25 to request the necessary battery power load to drive the electric motor 56 to supply pressurized fluid to the hydraulics 150. In some examples, the controller 106 provides electrical power from the battery pack 52 to an inverter 112, which can convert DC power from the battery pack 52 (and from the PDU 25) to AC power for use by the electric motor 56. In some examples, the inverter 112 can be used to vary the frequency of the transformed AC power to adjust the performance of the electric motor 56. In some examples, the inverter 112 can be used to convert electrical power from the battery pack 52 into AC power for use by the prime mover 20, shown as an electric motor 20 as well. In some examples, each of the frame 12 and the body 14 include separate inverters 112 that can be used to supply AC electrical power to components on the frame 12 and body 14, respectively. The frequency output of the inverter 112 can be adjusted by the controller 106 and/or a variable frequency drive.

The controller 106 at least partially controls the pump 58 and electric motor 56 to deliver pressurized hydraulic fluid to accommodate variable pump loads that may be requested by the hydraulics 150 during normal refuse truck 10 operation. The controller 106 receives signals from various inputs throughout the refuse truck 10 and can subsequently control different components within the body 14 hydraulic circuit to execute different tasks. For example, the controller 106 may receive an input from one or more buttons within the cab 16 of the refuse truck 10 that prompt the lift assembly 40 to move in order to raise and empty the contents of a waste receptacle into the refuse compartment 30 of the refuse truck 10. Upon receiving an input requesting an adjustment of the pump load (e.g., requested movement of the lift assembly 40 the controller 106 can activate or adjust an output of the electric motor 56 and pump 58 to deliver pressurized hydraulic fluid from a hydraulic fluid reservoir to the one or more actuators forming the pump load to carry out the requested operation. As depicted in FIG. 3, the controller 106 can work with the hydraulic pump 58 to supply hydraulic fluid to one or more of the lift assembly 40, the ejector 62, and the various other subsystems upon the body 14 (e.g., the tailgate 34, top door 38, etc.).

The controller 106 is also in communication with various auxiliary systems 350 on the body 14 and/or on the frame 12. For example, the controller 106 may communicate with and/or control the operation of the HVAC system 352, a can alignment system 354, a gate opener assembly 356, a global positioning system (GPS) 358, cab controls 360, the vehicle suspension 362, and other subsystems present upon the refuse truck 10. The controller 106 can provide communication between the auxiliary systems 350 and the PDU 25, and can selectively permit the transmission of electrical power from the battery pack 52 to the auxiliary systems 350 on the refuse truck 10. In some examples, the body 14 further supports a secondary battery 114. The secondary battery 114 can be configured to power the controller 106 and/or other subsystems on the body 14, including the E-PTO system 54 and the auxiliary systems 350. In some embodiments, the secondary battery 114 is placed in selective communication with the prime mover 20 to provide a backup ignition or drive source if the primary battery pack 52 becomes disabled or runs low on power.

Although the description of the E-PTO system and disconnect have been described within the context of a front end loading refuse truck, the same or similar systems can also be included in both side loading and rear end loading refuse trucks without significant modification. Accordingly, the disclosure should be considered to encompass the E-PTO system and pump in isolation and incorporated into any type or variation of refuse vehicle. Additionally, as described above, multiple torque-limited pumps may be incorporated into a single E-PTO system without departing from the scope of the present disclosure.

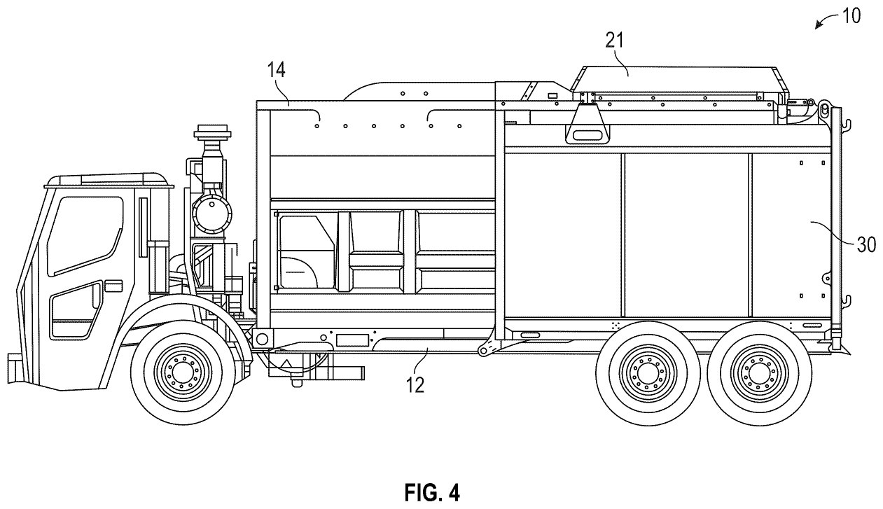

Still referring to FIG. 4, the refuse vehicle 10 includes a hydrogen power system 302. The hydrogen power system 302 includes a hydrogen fuel cell, shown as fuel cell 304 and a hydrogen fuel pod shown as hydrogen fuel pod 306. The hydrogen fuel pod 306 is selectively coupled to the hydrogen fuel cell 304 by a disconnect 308. The disconnect 308 can be a hydrogen shut off valve configured to control the flow of hydrogen from the fuel pod 306 to the fuel cell 304. The hydrogen fuel pod 306 provides hydrogen as a gas or as a liquid to the fuel cell 304. The hydrogen power system 302 generates energy to power one or more components of the refuse vehicle 10 or to be stored in an onboard storage device such as battery pack 52. The hydrogen power system 302 may operate alone or in combination with one or more other power systems of the refuse vehicle (e.g., the prime mover 20, the battery pack 52, the electric motor 56, the hydraulic pump 58, etc.) to power one or more components of the refuse vehicle. In this manner, the hydrogen power system 302 is configured to provide energy to perform at least one of a driving operation or a body operation of the refuse vehicle 10. In some embodiments, the hydrogen power system 302 is coupled to the controller 106 and/or the PDU 25 via a disconnect 310. The disconnect 310 may be selectively operable by controller 106 and/or a controller within the hydrogen power system 302 to selectively disconnect the hydrogen power system from the controller 106 and the PDU 25.

While shown in FIG. 3 as being used in combination with an electrical power system (e.g., electric motor 20, battery pack 52) as described above the hydrogen power system 302 may also be used in conjunction with types of prime mover 20 using a variety of fuels (e.g., gasoline, diesel, biodiesel, ethanol, natural gas, liquid hydrogen, hydrogen gas, etc.) or power sources (e.g., ultra-capacitors), on-board generators (e.g., an internal combustion engine, high efficiency solar panels, regenerative braking system, hydrogen power system, etc.), or from an external power source (e.g., overhead power lines). Each power source has its own unique characteristics which can be supplemented by the hydrogen power system 302. Certain fuel types or power sources take more time to turn on/off, and the hydrogen power system 302 can be used to bridge gaps between the power requested and the power able to be provided by the other power sources.

In some embodiments, the controller 106 determines the type of power source being used by the refuse vehicle (e.g., battery pack 52, diesel ICE as prime mover 20, etc.) and determines if supplemental power from the hydrogen power system 302 is required at either the start of the activation of the other power source or the termination of the use of the other power source.

The maximum power output of the hydrogen power system 302 can be sized dependent on other power sources and the operations of the refuse vehicle 10. In some embodiments, the hydrogen power system 302 has a maximum power output (e.g., electrical load or load capacity) greater than the electrical load of a body 14 and the components thereon. In such embodiments, the hydrogen power system 302 can be used to power both the body 14 and the components thereof, as well as the battery pack 52 or other onboard storage devices used for moving the refuse vehicle 10. Beneficially, by using the hydrogen power system 302 to supplement the power available to the chassis (i.e., the prime mover 20) the hydrogen power system 302 can increase the range of the refuse vehicle 10 and/or reduce the need for additional body mounted batteries (e.g., secondary battery 114).

Still referring to FIG. 3, the hydrogen power system 302 is coupled to the controller 106 and the PDU 25 by junction box 312. The junction box 312 interfaces with the hydrogen power system 302. For example, the junction box 312 may include one or more hydrogen connectors for connecting to external hydrogen fuel pods and/or one or more electrical interfaces configured to provide power to and from the hydrogen power system 302. In some embodiments, the junction box 312 also includes a separate disconnect box. The disconnect box can include one or more switches, diodes, disconnects, or other interrupting devices to electrically disconnect the hydrogen power system 302 from the refuse vehicle 10. The disconnect 310 can be external to both the junction box 312 and the disconnect box 310.

One or more of the components of the hydrogen power system 302 may be contained within a detachable housing or pod such as pod assembly 21. The pod assembly 21 may contain the entire hydrogen power system 302 or one or more components thereof (e.g., fuel cell 304, fuel pod 306, etc.). For example, the pod assembly 21 may contain the fuel cell 304, and a second pod assembly 21 may contain the fuel pod 306. The pod assemblies 21 may be coupled to each other either directly or via the refuse vehicle 10 to exchange power and/or hydrogen. The hydrogen power system 302 or one or more components thereof of the hydrogen power system 302 may be a modular components of the refuse vehicle 10 that can be readily exchanged with another hydrogen power system 302, fuel cell 304, or fuel pod 306. In this sense, for example, the hydrogen fuel cell 304 may be removed from the refuse vehicle (e.g., to perform maintenance) and a different hydrogen fuel cell 304 may be loaded into the refuse vehicle 10 to reduce downtime of the refuse vehicle 10. In some embodiments, the hydrogen power system 302 is secondary or supplemental power system such that a driving operation of the refuse vehicle 10 can be completed without power from the hydrogen power system 302. In such embodiments, one or more components of the hydrogen power system 302 can be removed from the refuse vehicle 10 (e.g., for maintenance or repair) and the refuse vehicle can still perform the driving operation, and then the component can be reattached at a end of the driving operation. The hydrogen power system 302

According to various embodiments, the hydrogen power system 302 may include more than one hydrogen fuel cell 304 and/or more than one hydrogen fuel pod 306 in a plurality of pod assemblies 21. For example, the hydrogen power system 302 may include two or more hydrogen fuel pods 306 configured to drive the hydrogen fuel cell 304. According to various embodiments, including additional hydrogen fuel cells 304 and/or hydrogen fuel pods 306 in the hydrogen power system 302 will enable the hydrogen power system 302 to provide more power to the refuse vehicle 10 Since the hydrogen power system 302 can be easily exchanged with another hydrogen power system 302, different hydrogen power systems 302 may be selected based on the desired use of the refuse vehicle 10. For example, if the refuse vehicle 10 is intended to be used for relatively heavy lifting, a hydrogen power system 302 with more than one hydrogen fuel cell 304 and/or hydrogen fuel pod 306 may be installed into the refuse vehicle 10.

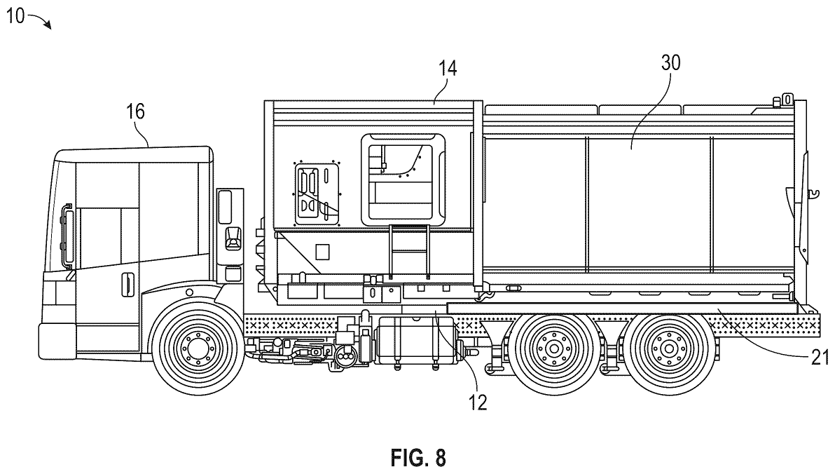

Referring now generally to FIGS. 4-11, the hydrogen power system 302 or components thereof (e.g., fuel cell 304, fuel pod 306), may be positioned in one or more pod assemblies 21 in various locations on the refuse vehicle 10. In some embodiments, the fuel cell 304 and the fuel pod 306 are positioned together in the same pod assembly 21 at the same location. In other embodiments, the fuel cell 304 and the fuel pod 306 are packaged separately in separate pod assemblies 21 and positioned at different locations on the refuse vehicle 10. In some examples, the pod assembly 21 (e.g., hydrogen power system 302, fuel cell 304, and/or fuel pod 306) can be coupled to the frame 12, the body 14, the cab 16, or other parts of the refuse vehicle 10. In other embodiments, the refuse vehicle 10 may include more than pod assembly 21. In these arrangements, each of the pod assemblies 21 may similarly be coupled to the frame 12, the body 14, the cab 16, or other parts of the refuse vehicle 10. The geometry of the pod assembly 21 may change to suitably conform to the location of the pod assembly 21.

As shown in FIG. 4, the pod assembly 21 is coupled to the rearward top portion of the body 14. In other embodiments, the pod assembly 21 is coupled to the forward top portion of the body 14. In some embodiments, the pod assembly 21 is removable/detachable from the body 14. Locating the pod assembly 21 on top of the body 14 allows easy access to the pod assembly 21. For example, a user may readily inspect and service the pod assembly 21 because it is located on an external surface of the refuse vehicle 10.

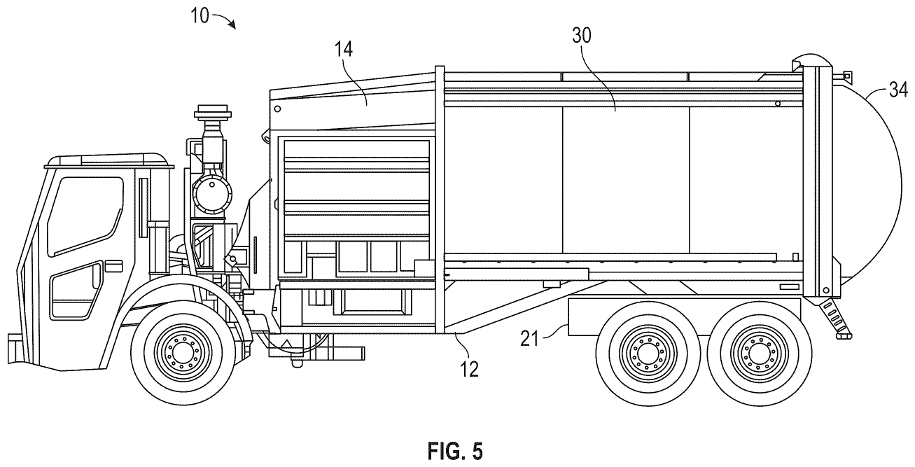

As shown in FIG. 5, the pod assembly 21 is coupled to the rearward bottom portion of the body 14. In other embodiments, the pod assembly 21 is coupled to the forward bottom portion of the body 14. As described above, pod assembly 21 may be removable/replaceable. For example, the refuse vehicle 10 may include a door on the side of the body 14 to allow removal and replacement of the pod assembly 21. In some embodiments, the pod assembly 21 is located on a track such that the pod assembly 21 can be slid out from the body 14 similar to a drawer.

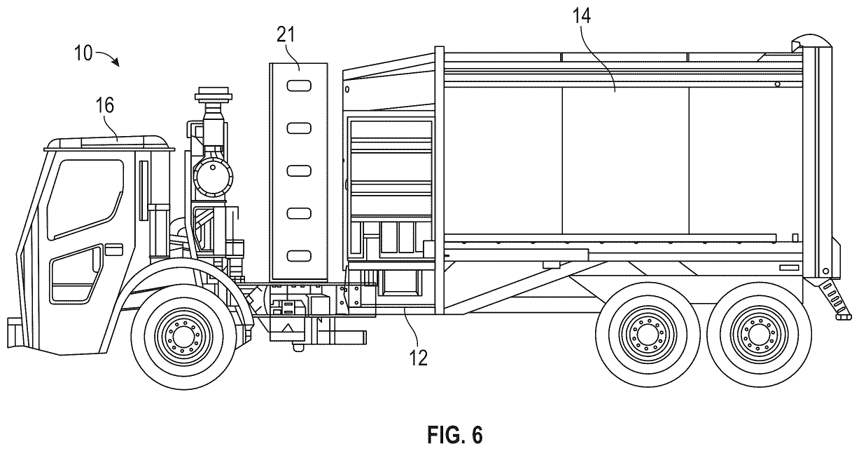

As shown in FIG. 6, the pod assembly 21 is coupled between the cab 16 and the body 14. In some embodiments, the pod assembly 21 is coupled to the frame 12. Locating the pod assembly 21 between the cab 16 and the body 14 reduces a rear weight of the refuse vehicle 10, thereby reducing component stress of weight bearing members (e.g., a rear axle). Furthermore, centrally locating the pod assembly 21 protects the pod assembly 21 from damage in a mechanical impact event. Furthermore, centrally locating the pod assembly 21 allows easy modification/retrofitting of existing refuse vehicles to include the pod assembly 21. The pod assembly 21 may be easily accessed and/or removed from the refuse vehicle 10. For example, the pod assembly 21 may include forklift pockets so that a forklift may easily remove the pod assembly 21 from the refuse vehicle 10. In some embodiments, the pod assembly 21 includes one or more eyelet connectors to receive a lifting hook or similar hoisting attachment. The pod assembly 21 may be configured to connect to an external rail system to quickly replace the pod assembly 21 by sliding it orthogonally off the refuse vehicle 10.

In some embodiments, the pod assembly 21 is configured to dynamically change position on the refuse vehicle 10 based on loading of the refuse vehicle 10. For example, the pod assembly 21 may translate horizontally along the frame 12 toward the cab 16 or toward the body 14 to change a weight distribution of the vehicle. In some embodiments, the pod assembly 21 includes one or more controllers to measure the weight distribution of the refuse vehicle 10 and adjust a position of the pod assembly 21 accordingly.

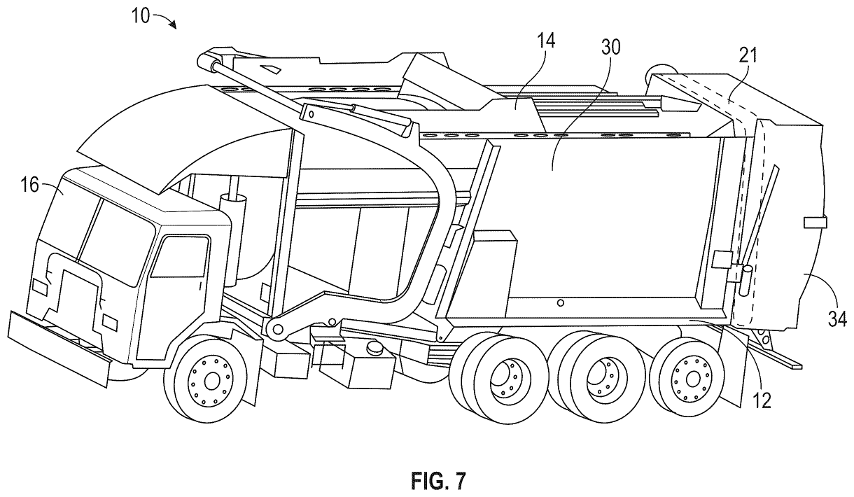

As shown in FIG. 7, the pod assembly 21 is coupled to the tailgate 34 of the refuse vehicle 10. In some embodiments, the pod assembly 21 is positioned vertically along a rearward side of the refuse compartment 30. In some embodiments, the pod assembly 21 is positioned substantially near the base of the tailgate 34 or as part of the tailgate 34. The pod assembly 21 may be configured to be accessible via the tailgate 34. For example, a user could open the tailgate 34 to reveal pod assembly 21. In some embodiments, the tailgate 34 includes one or more rotating elements (e.g., hinges, mechanical bearings) to facilitate rotation around a rearward corner of the refuse compartment 30. For example, the tailgate 34 could include one or more hinging mechanisms on a side to allow a user to open the tailgate 34 like a door and gain access to the pod assembly 21 located along the frame 12 of the refuse vehicle 10. In some embodiments, the tailgate 34 is a double door. Swinging the tailgate 34 open like a door requires less energy than lifting the tailgate 34.

In some embodiments, the tailgate 34 is fully integrated with the pod assembly 21 and is configured to be removable/replaceable. For example, a first tailgate 34 having a first pod assembly 21 could be replaced by a second tailgate 34 having a second pod assembly 21 when the fuel pods 306 of the first pod assembly 21 are empty. Removing and replacing the tailgate 34 may limit loss of vehicle operation due to refueling time because the tailgate 34 including the depleted pod assembly 21 may be fueled separately of the refuse vehicle 10. Furthermore, swappable hydrogen power systems 302 enables a smaller fleet of refuse vehicles to service the same area because the reduced downtime associated maintenance and repair enables the refuse vehicles to operate for longer periods of time.

As shown in FIG. 7, the pod assembly 21 is coupled between the body 14 and the frame 12 (e.g., on a sub-frame). As described above, in some embodiments, the pod assembly 21 may be configured to translate horizontally along the frame 12 of the refuse vehicle 10. For example, the pod assembly 21 could move between a forward portion and a rearward portion of the body 14 of the refuse vehicle 10 such that the refuse vehicle 10 is evenly loaded. As described above, in some embodiments, the pod assembly 21 is removable and/or replaceable. The pod assembly 21 may be accessed via a door on a side of the body 14 or via the tailgate 34. Similarly, the pod assembly 21 may be removed and/or replaced by another pod assembly 21. Alternatively, one or more individual components (e.g., fuel cell 304, fuel pod 306) of the pod assembly 21 could be replaced. In some embodiments, the pod assembly 21 can be accessed by removing the refuse compartment 30. For example, a refuse vehicle with a removable refuse compartment (e.g., a container truck) may remove the refuse compartment to reveal the pod assembly 21. In some embodiments, the pod assembly 21 is coupled to the refuse compartment 30 itself and can be removed with the refuse compartment 30. For example, a refuse vehicle could swap a first full refuse compartment with a first pod assembly 21 having for a second empty refuse compartment with a second pod assembly 21.

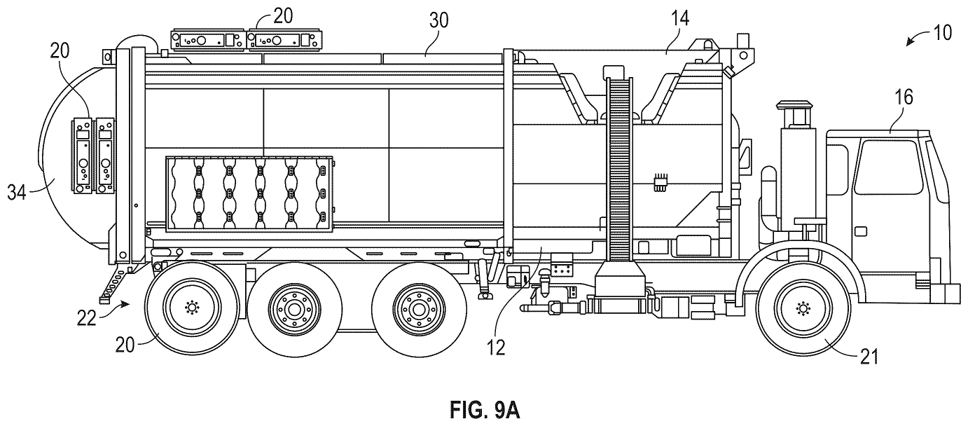

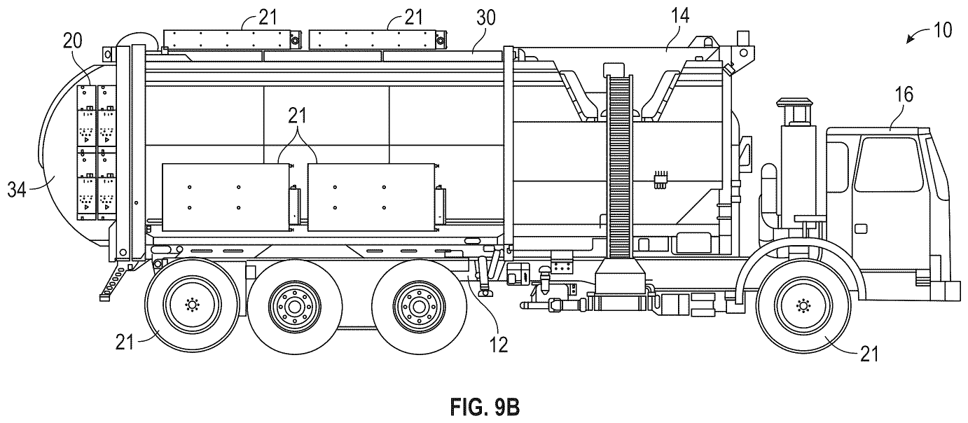

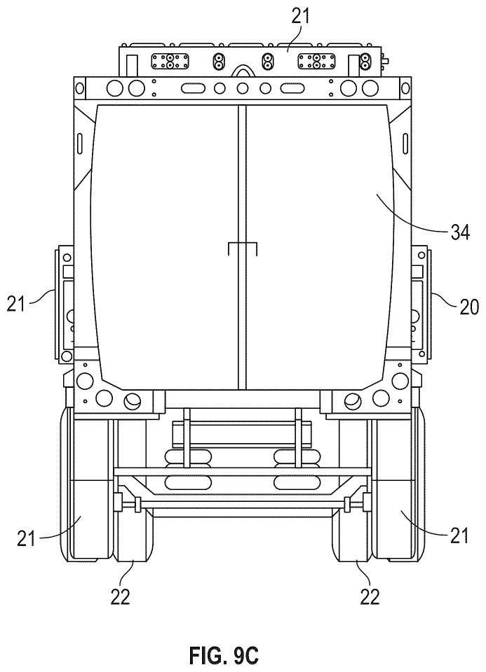

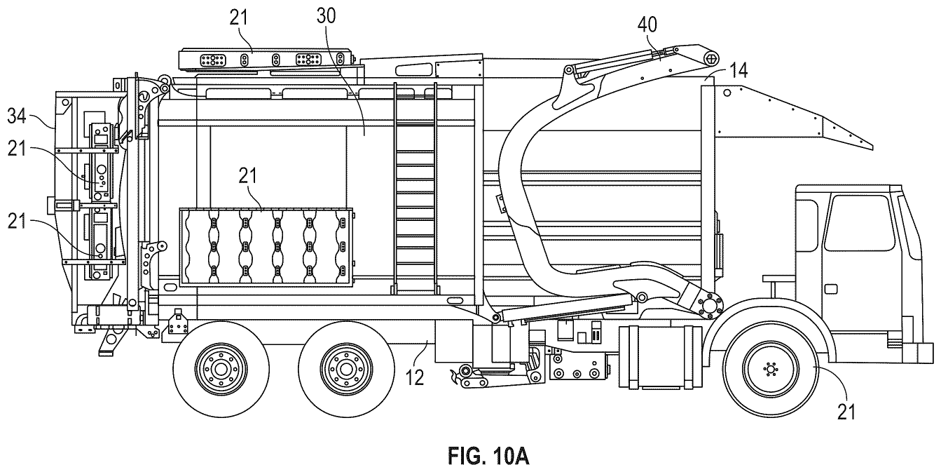

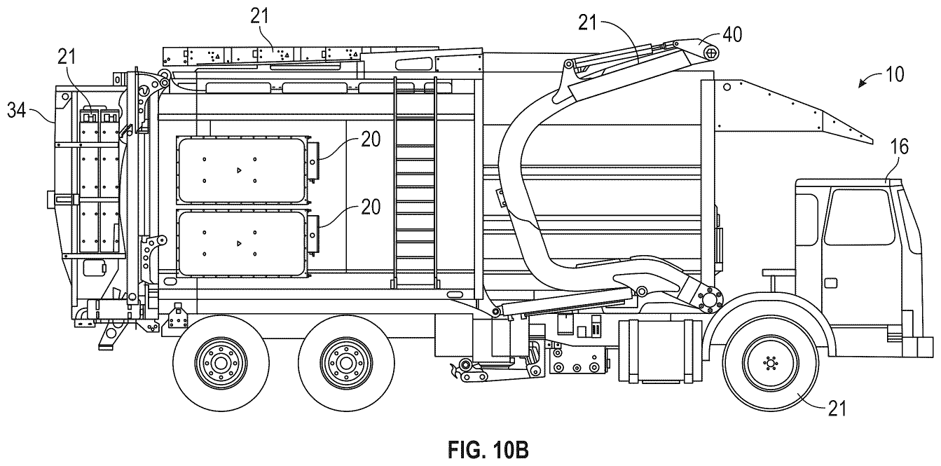

Referring now to FIGS. 9A-10B, several illustrations of an exemplary placement of the pod assembly 21 are shown, according to several exemplary embodiments. In various embodiments, the pod assembly 21 is coupled to a rearward top portion of the refuse vehicle 10 (e.g., above the refuse compartment 30, etc.). Additionally or alternatively, the pod assembly 21 is coupled to a rearward portion of the refuse vehicle 10. For example, the pod assembly 21 may be coupled to the tailgate 34 and/or a rearward portion of the refuse compartment 30 (e.g., as shown in FIGS. 9A-9C). As another example, the pod assembly 21 may be coupled to a vertical rear surface of the refuse compartment 30. In some embodiments, the pod assembly 21 or components thereof are coupled to the wheel 22. In some embodiments, the pod assembly 21 is coupled to a front and rear wheelset of the refuse vehicle 10 (e.g., as shown in FIGS. 9A-9C). In various embodiments, placement of the pod assembly 21 as shown in FIGS. 9A-9C facilitates shifting weight rearward on the refuse vehicle 10, thereby reducing strain on forward load bearing components (e.g., a front axle, etc.). In some embodiments, the placement of the pod assembly 21 shown in FIGS. 9A-9C is preferred for a rear-loading refuse vehicle 10. In various embodiments, the pod assembly 21 includes a different number and/or arrangement of components than shown explicitly in the FIGURES. For example, the pod assembly 21 may include a first component coupled to an exterior hub surface of the front wheels 22 electrically coupled to a second component integrated with the tailgate 34. In some embodiments, the placement of the pod assembly 21 shown in FIGS. 10A-10B is preferred for a front-loading refuse vehicle 10 and/or a side-loading refuse vehicle 10. For example, the pod assembly 21 may be positioned on the lift assembly 40. In various embodiments, the pod assembly 21, or components thereof, are detachable from the refuse vehicle 10 as described in detail above.

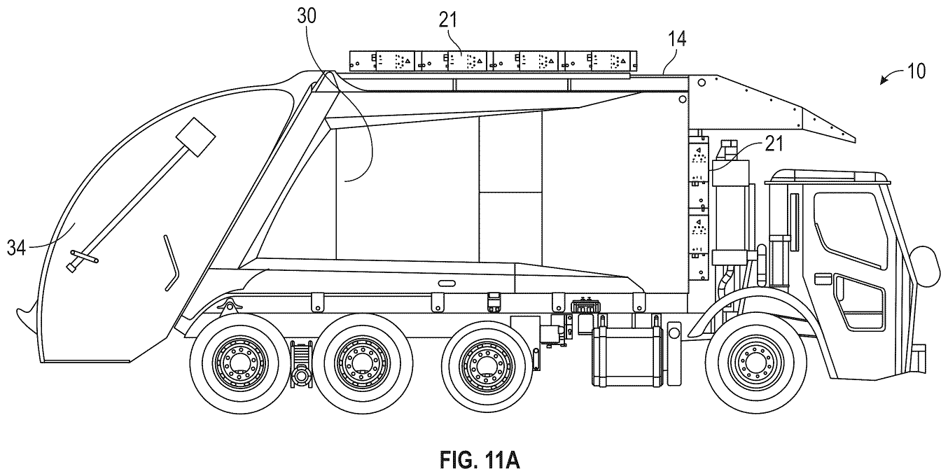

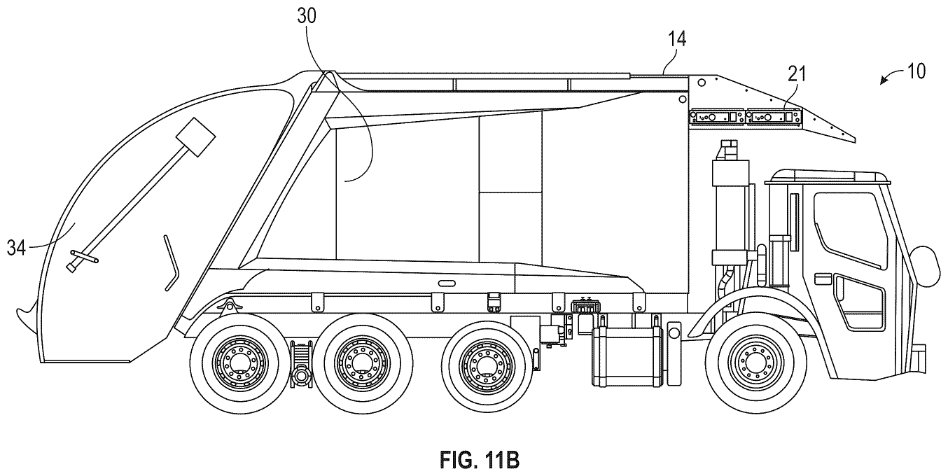

Referring now to FIGS. 11A-11B, several illustrations of another exemplary placement of the pod assembly 21 are shown, according to several exemplary embodiments. In various embodiments, the pod assembly 21 is coupled to a top portion of the refuse vehicle 10. For example, the pod assembly 21 may be coupled to a top portion of refuse compartment 30 and/or above the cab 16 (e.g., as shown in FIGS. 11A-11B). In some embodiments, the pod assembly 21 is coupled to a canopy (or other structural element) located above the cab 16. Additionally or alternatively, the pod assembly 21, or components thereof, may be coupled to the wheels 22. For example, a first component of the pod assembly 21 (e.g., a fuel pod 306) may be coupled to an exterior hub region of the wheels 22 and a second component of the pod assembly 21 (e.g., a fuel cell 304) may be coupled to a structural element (e.g., a portion of frame 12, etc.) above the cab 16. In some embodiments, the placement of the pod assembly 21 shown in FIGS. 11A-11B is preferred for a rear-loading refuse vehicle 10. In various embodiments, the placement of the pod assembly 21 as shown in FIGS. 11A-11B facilitates moving weight (e.g., battery weight, etc.) forward on the refuse vehicle 10 (e.g., toward the cab 16 and away from the tailgate 34, etc.), thereby reducing stress on rear load-bearing components (e.g., a rear axle, etc.).

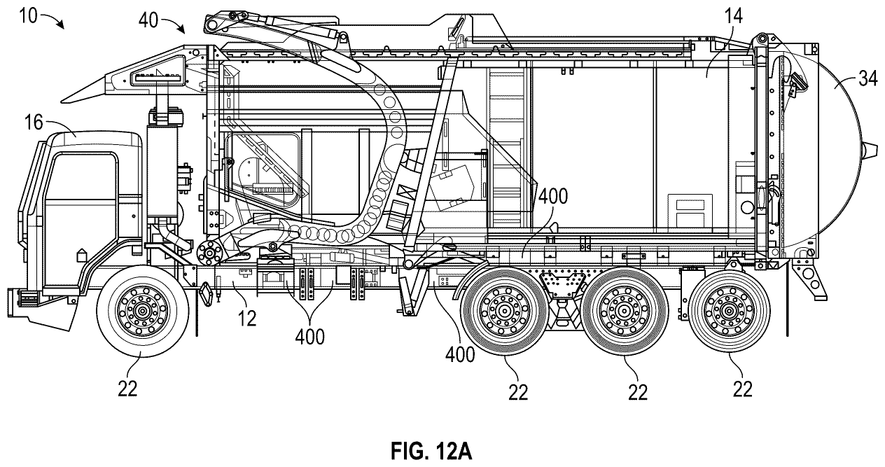

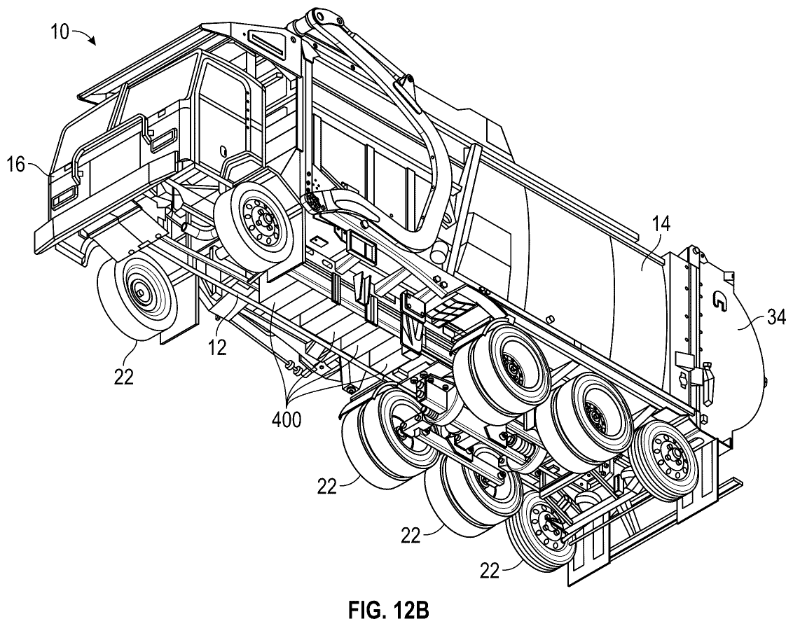

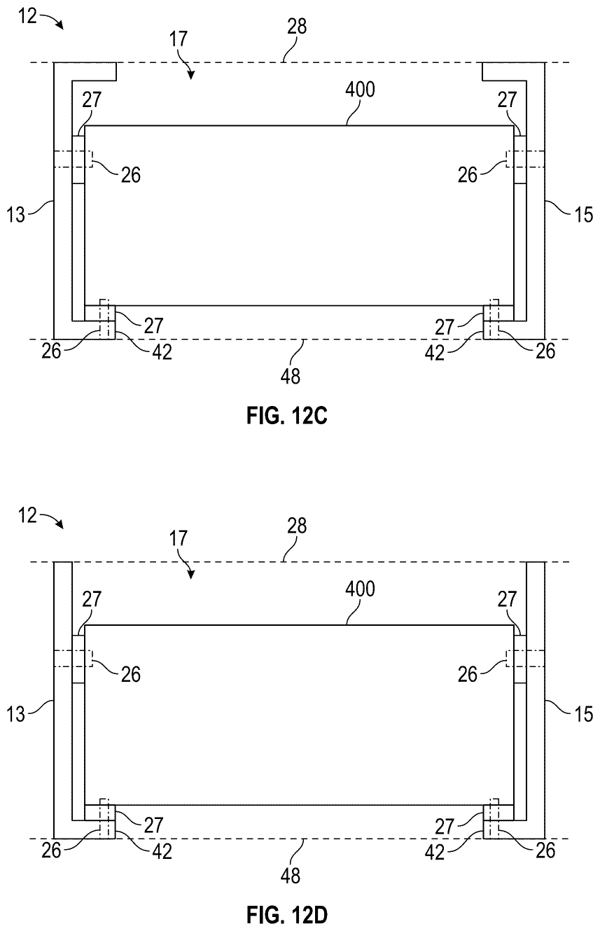

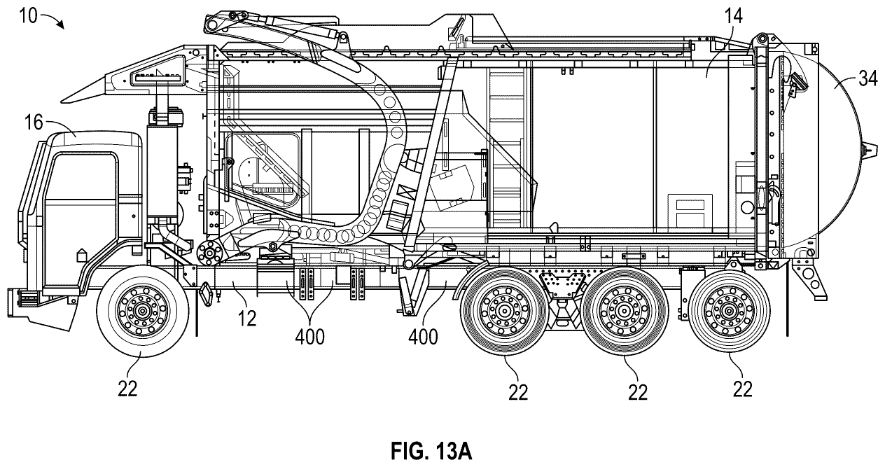

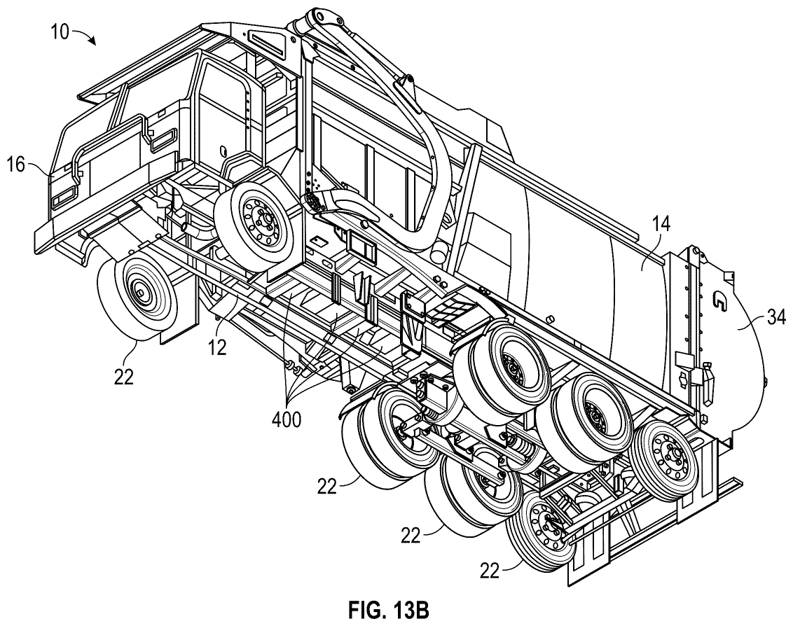

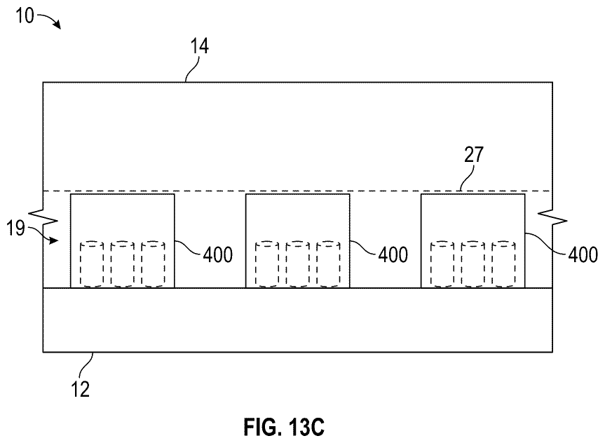

Referring now to FIGS. 12A-12B and 13A-13B, the refuse vehicle 10 includes one or more hydrogen power systems 302 or components thereof (e.g., fuel cell 304, fuel pod 306, etc.) for providing electrical power or electrical energy to various electrical components of the refuse vehicle 10, according to an exemplary embodiment. For example, the hydrogen power system 400 can provide or discharge electrical energy to power one or more components, devices, lift assemblies, compaction apparatuses, chassis systems, body systems, accessories, lights, etc., of the refuse vehicle 10. The hydrogen power system 400 described herein may be the same as or similar to the hydrogen power system 302 in the pod assembly 21 described in greater detail above, according to one exemplary embodiment. In another exemplary embodiments, the hydrogen power system 400 described herein can be housings that are structurally coupled with the refuse vehicle 10 that include hydrogen fuel cells 304 and/or hydrogen fuel pods 306.

Referring particularly to FIGS. 12A-12D, the hydrogen power system 400 can be positioned between rails of the frame 12, according to an exemplary embodiment. The frame 12 can include a left frame member 15 and a right frame member 13 that are spaced apart in a lateral direction perpendicular to the longitudinal direction. The frame 12 extends in and/or defines a longitudinal direction of the refuse vehicle 10. The hydrogen power system 400 can be spaced apart along the left frame member 15 and the right frame member 13. Referring particularly to FIGS. 12C-12D, the right frame member 13 and the left frame member 15 can be C-shaped brackets (shown in FIG. 12C), L-shaped brackets (shown in FIG. 12D), or any other shaped brackets. The right frame member 13 and the left frame member 15 define a space, a volume, an area, a gap, etc., therebetween, shown as space 17. The space 17 may have a height that is substantially equal to a height (e.g., in a lateral direction) of the right frame member 13 and the left frame member 15. In some embodiments, the hydrogen power system 400 is positioned within the space 17 between the right frame member 13 and the left frame member 15. In some embodiments, the hydrogen power system 400 is positioned between the right frame member 13 and the left frame member 15 and are longitudinally spaced (as shown in at least FIGS. 12A-12B) along the frame 12. The hydrogen power system 400 can be equally spaced along the frame 12, or unevenly spaced.

Referring particularly to FIGS. 12C-12D, the hydrogen power system 400 can be coupled with the right frame member 13 and the left frame member 15 along a top, a bottom, or sides of the hydrogen power system 400. For example, the hydrogen power system 400 can be coupled with the right frame member 13 and the left frame member 15 through fasteners 26 and dampers 27. The dampers 27 can be positioned between an interior surface of the right or left frame members 13 or 15 and an exterior surface of the hydrogen power system 400 (or a housing thereof) to absorb vibrations that may occur when the refuse vehicle 10 operates (e.g., as the refuse vehicle 10 transports). The fasteners 26 may pass through an opening of the dampers 27 and extend a distance into the hydrogen power system 400 (e.g., a housing of the hydrogen power system 400) and at least partially into the right frame member 13 or the left frame member 15.

In some embodiments, a top portion, a top edge, an upper periphery, etc., of the frame 12 defines a first plane or a first boundary 28 (e.g., an upper periphery or boundary of the space 17), and a bottom portion, a bottom edge, a lower periphery, etc., of the frame 12 defines a second plane or a second boundary 48 (e.g., a lower periphery or boundary of the space 17). In some embodiments, the hydrogen power system 400 is positioned entirely within the space 17 between the first boundary 28 and the second boundary 48. In some embodiments, the hydrogen power system 400 is positioned above the second boundary 48 so that the hydrogen power system 400 do not protrude downwards beyond the second boundary 48.

In some embodiments, dampers 27 and fasteners 26 are used to couple the hydrogen power system 400 with a bottom portion 42 of the right frame member 13 and the left frame member 15 (e.g., if the frame members 13 and 15 include bottom flanges such as in the L-shaped and C-shaped configurations shown in FIGS. 12C-12D). In some embodiments, the hydrogen power system 400 rest on top of the bottom portions 42 of the right frame member 13 and the left frame member 15 (e.g., with or without the dampers 27 positioned therebetween). In some embodiments, the dampers 27 and fasteners 26 are arranged along a top or bottom surface to absorb longitudinal vibrations, and/or along sides of the hydrogen power system 400 to absorb transverse or lateral vibrations.

Referring particularly to FIGS. 13A-13C, the hydrogen power system 400 can be positioned between the frame 12 and the body 14 (e.g., in a floor of the body 14). In some embodiments, the body 14 and the frame 12 define a space 19 therebetween (e.g., between a floor surface 67 of the body 14 and a top surface or upper periphery of the frame 12). The hydrogen power system 400 can be positioned within the space 19 and spaced longitudinally along the frame 12 and the body 14 (e.g., as shown in FIG. 13C). In some embodiments, the hydrogen power system 400 is fastened to the body 14 and hang from an underside of the body 14. In some embodiments, the hydrogen power system 400 is coupled with the body 14 and/or the frame 12 similarly to as described in greater detail above with reference to FIGS. 12A-12D. In some embodiments, the hydrogen power system 400 hang from the underside of the body 14, or are positioned within a floor of the body 14. The hydrogen power system 400 can extend downwards and terminate at an upper surface of the frame 12, terminate above the upper surface of the frame 12, or extend into the space 17 between the frame members 13 and 15. In some embodiments, the hydrogen power system 400 is also coupled with the frame 12.

The hydrogen power system 400 can be positioned at least partially within the space 19 defined by the body 14 and the frame 12. In some embodiments, the hydrogen power system 400 extend upwards into a space 65 within the body 14 so that the hydrogen power system 400 is at least partially positioned within the space 65. For example, the hydrogen power system 400 can be positioned at a floor surface 67 of the body 14 and may extend at least partially downwards into the space 19 between the body 14 and the frame 12 (e.g., terminating within the space 19, terminating at a boundary of the space 19, etc.).

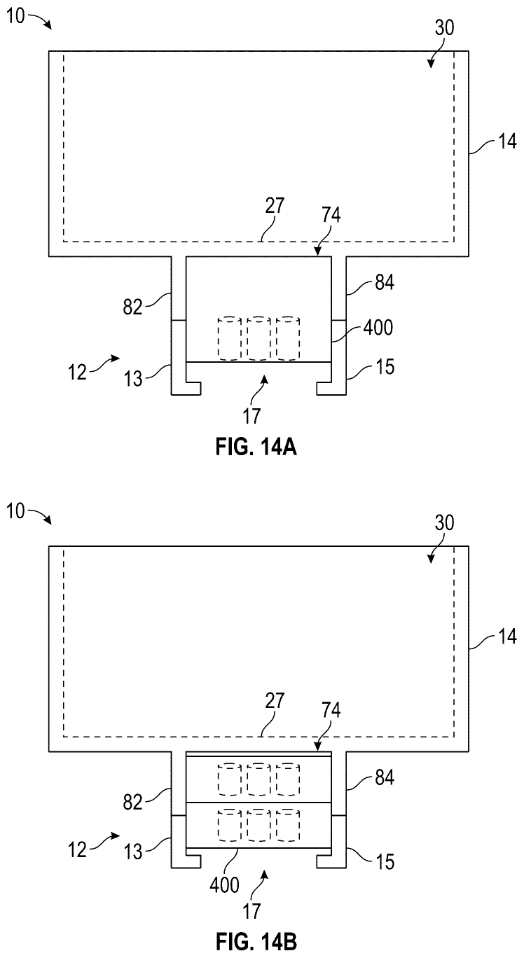

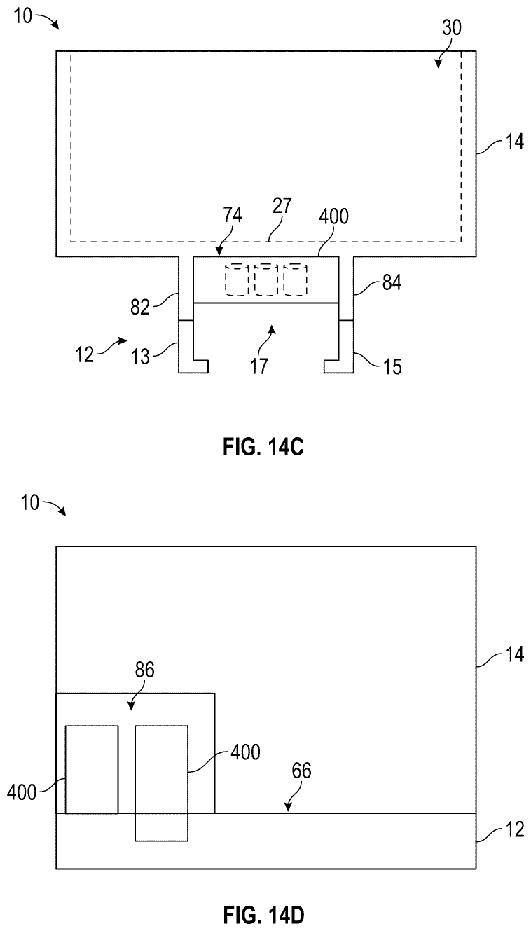

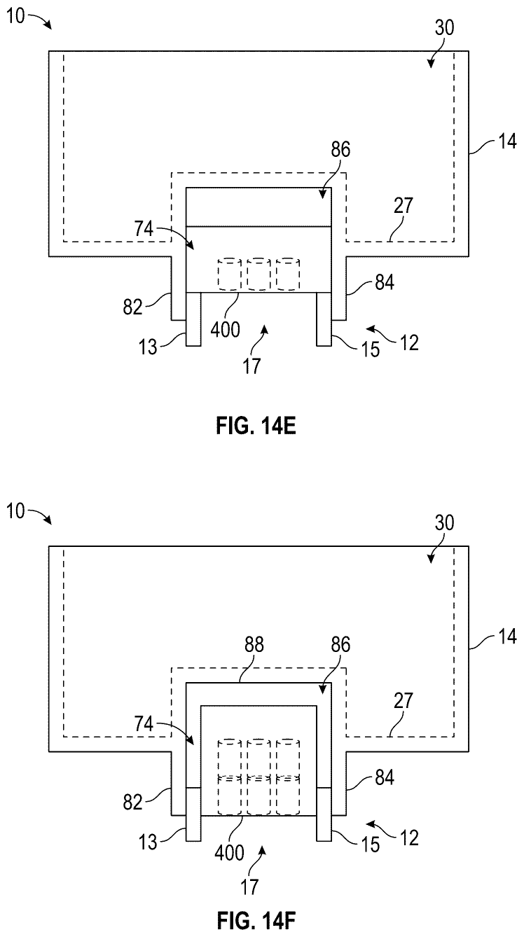

Referring particularly to FIG. 14A, the body 14 may include a right frame member 82 and a left frame member 84 (e.g., a right body frame member and a left body frame member), according to an exemplary embodiment. The right frame member 82 and the left frame member 84 of the body 14 extend in a same direction as the frame 12. Specifically, the right frame member 82 and the left frame member 84 extend in the longitudinal direction along at least a portion of an entire longitudinal length of the body 14. The right frame member 82 and the left frame member 84 can be spaced apart a lateral distance that is equal to, greater than, or less than the lateral spacing of the right frame member 13 and the left frame member 15. The right frame member 13 and the left frame member 15 are chassis frame members, while the right frame member 82 and the left frame member 84 are body frame members. The right frame member 82 and the left frame member 84 can be continuous structural members that extend substantially an entire length of the body 14, or may be multiple discrete sections that extend along the entire length of the body 14. The right frame member 82 and the left frame member 84 can be configured to abut, rest upon, etc., the right frame member 13 and the left frame member 15, or may be configured to extend along lateral outer surfaces of the right frame member 13 and the left frame member 15, respectively, or may be configured to extend along lateral inwards surfaces of the right frame member 13 and the left frame member 15, respectively. In any of these configurations, the body 14 is fixedly coupled with the frame 12 through the frame members 82 and 84 and the frame members 13 and 15. The right frame member 82 and the left frame member 84 are rails, bars, beams, etc., and may have an I-shape, a rectangular shape, a T-shape, an L-shape, etc. The right frame member 82 and the left frame member 84 extend from an underside or bottom surface of the body 14, or may extend downwards from the floor surface 67 of the body 14 (e.g., the floor surface 67 of the refuse compartment 30).

As shown in FIG. 14A and described in greater detail above, the right frame member 13 and the left frame member 15 define the space 17 therebetween. The right frame member 82 and the left frame member 84 similarly define a space 74 therebetween. The hydrogen power system 400 can be positioned between the right frame member 13 and the left frame member 15, and also between the right frame member 82 and the left frame member 84. Specifically, the hydrogen power system 400 can be positioned within both the space 17 and the space 74. The hydrogen power system 400 can be fixedly coupled with the right frame member 82 and the left frame member 84 of the body 14 (e.g., fastened), fixedly coupled with the right frame member 13 and the left frame member 15 of the frame 12 (e.g., fastened), hung from underside of the body 14 (e.g., from the floor surface 67), and may extend into the space 74, or the space 17. For example, in some embodiments, the hydrogen power system 400 hang from the floor surface 67 and extend into the space 74 and/or the space 17.

Referring now to FIG. 14B, the hydrogen power system 400 can also be stacked relative to each other (e.g., in a vertical direction as shown) and positioned within the spaces 17 and 72. As shown in FIG. 14B, the hydrogen power system 400 can be positioned within both the spaces 17 and 72, with one of the hydrogen power system 400 positioned at least partially within the space 17, and another of the hydrogen power system 400 positioned at least partially within the space 74. In other embodiments, multiple hydrogen power systems 400 or components thereof (e.g., fuel cells 304, fuel pods 306) are stacked relative to each other in a lateral direction between the right frame member 13 and the left frame member 15, between the right frame member 82 and the left frame member 84, or between both the right frame member 13 and the left frame member 15 and the right frame member 82 and the left frame member 84.

Referring to FIG. 14C, the hydrogen power system 400 is positioned within the space 74 between the right frame member 82 and the left frame member 84, but not within the space 17 between the right frame member 82 and the left frame member 84, according to another embodiment. In this embodiment, the hydrogen power system 400 is positioned proximate the underside of the body 14 (e.g., beneath the surface 67) but above the frame 12. Advantageously, positioning the hydrogen power system 400 as shown in FIG. 14C facilitates a tighter configuration with the hydrogen power system 400 shielded from debris or objects as the refuse vehicle 10 travels, due to the relative positioning between the hydrogen power system 400 and the underside of the body 14, between the longitudinal frames 82 and 84 of the body 14. The hydrogen power system 400 can be coupled with the body 14 by hanging from the underside of the body 14, fixed coupling with the hydrogen power system 400 and the right and left frame members 82 and 84, or both. The hydrogen power system 400 can be coupled with the right and left frame members 82 and 84 similarly as the hydrogen power system 400 is coupled with the right and left frame members 13 and 15 as described in greater detail above with reference to FIGS. 12C-12D.

Referring to FIG. 14D, the hydrogen power system 400 is positioned at least partially, or entirely, within a space 86 of the body 14, according to various exemplary embodiments. The space 86 is a tunnel, recessed area, or offset area relative to the floor surface 67 of the body 14. In this way, when the hydrogen power system 400 is positioned at least partially or entirely within the space 86, the hydrogen power system 400 extend upwards into the space 86 of the body 14 above the floor surface 67 of the body 14. In any of the configurations where the hydrogen power system 400 extend at least partially into the space 86, the hydrogen power system 400 may rest atop a top surface of the frame 12 (e.g., the right and left frame members 13 and 15), may be coupled with the right frame member 82 and the left frame member 84 of the body 14, and/or may be coupled with the right and left frame members 13 and 15. In any of the configurations where the hydrogen power system 400 extend at least partially into the space 86 of the body 14, the hydrogen power system 400 can extend between the right frame member 82 and the left frame member 84, or may extend between both (i) the right frame member 82 and the left frame member 84 of the body 14, and (ii) the right frame member 13 and the left frame member 15 of the frame 12.

The space 86 may be a tunnel or void that extends in the longitudinal direction along the body 14. The space 86 can also extend in the lateral direction along a width of the body 14. For example, the space 86 may extend in the lateral direction a distance that is substantially equal to a lateral spacing of the right frame member 82 and the left frame member 84 of the body 14, or a distance that is greater than a lateral spacing of the right frame member 82 and the left frame member 84. The space 86 can be an area that a prime mover (e.g., electric motor 20) and a transmission of the refuse vehicle 10 are positioned. The space 86 can also accommodate positioning of one or more of components of the hydrogen power system 400 as described herein.

Referring particularly to FIG. 14E, the hydrogen power system 400 is shown extending into the space 86 of the body 14, while occupying space between the first frame member 82 and the second frame member 84 of the body 14, but not occupying space between the first frame member 13 and the second frame member 15 of the frame 12. Particularly, the hydrogen power system 400 can be stacked or rest on top of the right frame member 13 and the left frame member 15 of the frame 12, and extend upwards, past the floor surface 67 of the body 14, into the space 86 of the body 14. In some embodiments, the hydrogen power system 400 is fixedly coupled (e.g., fastened) with the right frame member 82 and the left frame member 84 of the body 14, and extend upwards into the space 86 of the body 14. In some embodiments, the right frame member 82 and the left frame member 84 of the body 14 rest upon a top surface of the right frame member 13 and the left frame member 15 of the frame 12. The hydrogen power system 400 can be stacked on top of each other and at least partially extend into the space 86 of the body 14.

Referring particularly to FIG. 14F, the hydrogen power system 400 can be positioned to extend into the space 86, and to also extend into the space 17 between the first frame member 13 and the second frame member 15 of the frame 12. The hydrogen power system 400 can be fixedly coupled with the right frame member 13 and the left frame member 15 of the frame 12, and can be configured to extend through the space 74 defined between the right frame member 82 and the left frame member 84 of the body 14, and at least partially into the space 86. In some embodiments, the hydrogen power system 400 hang from an upper surface of the body 14 within the space 86 (e.g., the hydrogen power system 400 is hung from a surface 88 of the body 14) and extend into the space 86. The hydrogen power system 400, when hung from the surface 88 of the body 14 may also extend downwards, past the floor surface 67 into the space 74 between the right frame member 82 and the left frame member 84 of the body 14, and/or extend past the right frame member 82 and the left frame member 84 of the body 14, at least partially into the space 17 between the right frame member 13 and the left frame member 15 of the frame 12.

Advantageously, positioning the hydrogen power system 400 between the frame 12 and the body 14 (as shown in FIGS. 13A-13C) or between the right frame member 13 and the left frame member 15 (as shown in FIGS. 12A-12D) facilitates a robust and compact packaging and placement of the hydrogen power system 400. Further, positioning the hydrogen power system 400 as shown in FIG. 12A-12D or 13A-13C facilitates a lower center of gravity of the refuse vehicle 10, thereby reducing a likelihood of rollover and improving ride stability. In some embodiments, the hydrogen power system 400 is configured to store hydrogen and provide electrical energy for usage on the refuse vehicle 10 (e.g., for use by the prime mover 20 to facilitate transportation of the refuse vehicle 10 or any other electric motor of the refuse vehicle 10). For example, the hydrogen power system 400 can be configured to provide electrical energy for one or more chassis operations or body operations (e.g., to operate a lift assembly of the refuse vehicle 10). In some embodiments, the hydrogen power system 400 facilitates a semi-electric refuse vehicle.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” etc.) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the refuse vehicle as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present disclosures. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a chassis comprising a right frame member and a left frame member spaced apart in a lateral direction and extending lengthwise in a longitudinal direction, the right frame member being separate from the left frame member;
a body supported by the right frame member and the left frame member, the body defining a refuse compartment;
a plurality of fuel cells longitudinally disposed along the chassis, positioned between the right frame member and the left frame member; and
a hydrogen fuel pod supported by the chassis and configured to provide hydrogen to the plurality of fuel cells.

2. The refuse vehicle of claim 1, wherein the plurality of fuel cells are fixedly coupled to at least one of the right frame member or the left frame member.

3. The refuse vehicle of claim 1, wherein the plurality of fuel cells are disposed within one or more housings, the one or more housings fixedly coupled with at least one of the right frame member or the left frame member.

4. The refuse vehicle of claim 1, wherein the hydrogen fuel pod is longitudinally disposed along the chassis, positioned between the right frame member and the left frame member.

5. The refuse vehicle of claim 1, wherein the hydrogen fuel pod is disposed within one or more housings, the one or more housings fixedly coupled with at least one of the right frame member or the left frame member.

6. The refuse vehicle of claim 1, further comprising:
an energy storage device supported by the chassis and configured to provide electrical power to a prime mover, wherein activation of the prime mover selectively drives the refuse vehicle;
a power distribution unit coupled to the energy storage device and the plurality of fuel cells and configured to control power transmission outward from the energy storage device and the plurality of fuel cells; and
a controller communicating with the power distribution unit to adjust a flow of electric power from the energy storage device and the plurality of fuel cells to the body.

7. The refuse vehicle of claim 6, wherein the plurality of fuel cells are configured to provide electrical power to the energy storage device.

8. The refuse vehicle of claim 6, further comprising an electric power take-off, wherein the electric power take-off includes a hydraulic pump and an electric motor, wherein the electric motor is configured to receive electrical power from at least one of the energy storage device or the plurality of fuel cells to drive the hydraulic pump to convert electrical power into hydraulic power.

9. The refuse vehicle of claim 8, wherein the electric power take-off has a first electrical load, and wherein the plurality of fuel cells are configured to provide electrical power for a second electrical load, the second electrical load larger than the first electrical load.

10. The refuse vehicle of claim 6, further comprising a junction box connecting the plurality of fuel cells and the power distribution unit.

11. The refuse vehicle of claim 10, further comprising a disconnect box connected between the plurality of fuel cells and the power distribution unit.

12. The refuse vehicle of claim 11, further comprising a shut-off valve coupled between the plurality of fuel cells and the hydrogen fuel pod and configured to control a flow of hydrogen from the hydrogen fuel pod to the plurality of fuel cells, wherein the shut-off valve is positioned external to the junction box and the disconnect box.

13. A refuse vehicle comprising:
a chassis;
an energy storage device coupled to the chassis and configured to provide electrical power to a prime mover, wherein activation of the prime mover selectively drives the refuse vehicle;
a body assembly for storing refuse therein supported by the chassis, the body assembly comprising a plurality of auxiliary power assembly attachment points;
a plurality of fuel cells selectively coupled to at least one of the plurality of auxiliary power assembly attachment points, wherein the plurality of fuel cells are configured to provide electrical power to at least one of the energy storage device or the prime mover; and
a hydrogen fuel pod selectively coupled to at least one of the plurality of auxiliary power assembly attachment points, the hydrogen fuel pod configured to provide a flow of hydrogen to the plurality of fuel cells.

14. The refuse vehicle of claim 13, wherein the chassis comprises a right frame member and a left frame member spaced apart in a lateral direction and extending lengthwise in a longitudinal direction, the right frame member being separate from the left frame member, and wherein the plurality of fuel cells are coupled to at least one of the plurality of auxiliary power assembly attachment points disposed along the chassis between the right frame member and the left frame member.

15. The refuse vehicle of claim 13, wherein the plurality of fuel cells are coupled to at least one of the plurality of auxiliary power assembly attachment points disposed below an underside of the body assembly.

16. The refuse vehicle of claim 13, further comprising an electric power take-off, wherein the electric power take-off includes a hydraulic pump and an electric motor, wherein the electric motor is configured to receive electrical power from at least one of the energy storage device or the plurality of fuel cells to drive the hydraulic pump to convert electrical power into hydraulic power.

17. The refuse vehicle of claim 16, wherein the electric power take-off has a first electrical load, and wherein the plurality of fuel cells are configured to provide electrical power for a second electrical load, the second electrical load larger than the first electrical load.

18. The refuse vehicle of claim 16, further comprising:
a power distribution unit coupled to the energy storage device and the plurality of fuel cells and configured to control power transmission outward from the energy storage device and the plurality of fuel cells; and
a controller communicating with the power distribution unit to adjust a flow of electric power from the energy storage device and the plurality of fuel cells to the body assembly.

19. The refuse vehicle of claim 13, wherein the plurality of fuel cells are configured as a range extender to supply electrical power from the body assembly to the prime mover to drive the refuse vehicle.

20. A refuse vehicle comprising:
a chassis;
a battery coupled to the chassis and configured to provide electrical power to an electric motor, wherein activation of the electric motor selectively drives the refuse vehicle;
a body assembly for storing refuse therein supported by the chassis, the body assembly comprising a plurality of auxiliary power assembly attachment points;
at least one hydrogen fuel cell contained within a hydrogen fuel cell housing selectively coupled to a first point of the plurality of auxiliary power assembly attachment points, wherein the at least one hydrogen fuel cell is configured to provide electrical power to at least one of the battery or the electric motor; and
at least one hydrogen fuel pod selectively coupled to a second point of the plurality of auxiliary power assembly attachment points, the at least one hydrogen fuel pod configured to provide a flow of hydrogen to the at least one hydrogen fuel cell, wherein the at least one hydrogen fuel pod is contained within a fuel pod housing separate from the hydrogen fuel cell housing.
